(19) United States
(12) Patent Application Publication
(10) Pub. No.: US 2019/0023190 A1
(43) Pub. Date: Jan. 24, 2019

(54) CARRIER ASSEMBLY

(71) Applicants: William G. Breen, Belmont, MI (US); Carol A. Breen, Belmont, MI (US)

(72) Inventors: William G. Breen, Belmont, MI (US); Carol A. Breen, Belmont, MI (US)

(21) Appl. No.: 16/007,423

(22) Filed: Jun. 13, 2018

Related U.S. Application Data
(60) Provisional application No. 62/536,024, filed on Jul. 24, 2017.

(51) Int. Cl. B60R 9/10; B60R 9/06

(52) U.S. Cl. CPC B60R 9/10; B60D 1/00; B60R 9/06

(57) ABSTRACT

A carrier assembly includes a hitch post configured to be received by a vehicle trailer hitch. A first track assembly includes a first member and a second member. A second track assembly includes a third member and a fourth member. The first and third members are coupled to the hitch post to define a platform and the second and fourth members are rotatably coupled to the respective first and third members to define a rotatable ramp. A third track assembly is positioned on the ramp between the second and fourth members. An arm extends between the third and fourth members.

### CROSS-REFERENCE TO RELATED APPLICATION

This application claims the benefit of and priority to U.S. Provisional Patent Application No. 62/536,024, filed on Jul. 24, 2017, entitle CARRIER ASSEMBLY, the entire disclosure of which is hereby incorporated herein by reference.

### FIELD OF THE DISCLOSURE

The present disclosure generally relates to carrier assemblies, and more particularly, to carrier assemblies for vehicles.

### BACKGROUND

Wheeled vehicles are often transported by a vehicle to be ridden in new locations. Certain styles of wheeled vehicles may be difficult and/or cumbersome to transport. Accordingly, new carrier assemblies for transporting wheeled vehicles may be advantageous.

### SUMMARY OF THE DISCLOSURE

According to at least one feature of the present disclosure, a vehicle carrier assembly includes a hitch post configured to be received by a vehicle trailer hitch. A first track assembly includes a first member and a second member. A second track assembly includes a third member and a fourth member. The first and third members are coupled to the hitch post to define a platform and the second and fourth members are rotatably coupled to the respective first and third members to define a rotatable ramp. A third track assembly is positioned on the ramp between the second and fourth members. An arm extends between the third and fourth members.

According to another feature of the present disclosure, a vehicle carrier assembly includes a hitch post. A first track assembly includes a first member and a second member. A second track assembly includes a third member and a fourth member. The first and third members are coupled to the hitch post to define a platform and the second and fourth members are rotatably coupled to the respective first and third members to define a rotatable ramp. A third track assembly is positioned on the ramp between the second and fourth members.

According to yet another feature of the present disclosure, a carrier assembly includes a hitch post and a first track assembly. A second track assembly, the first and second track assemblies coupled to the hitch post to define a platform and a ramp. The ramp is rotatably coupled to the platform and operable between deployed and undeployed positions. A third track assembly is positioned on the ramp and positioned between the first and second track assemblies.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a perspective view of a carrier assembly, according to at least one example;

FIG. 2A is a perspective view of the carrier assembly of FIG. 1 in a deployed position, according to at least one example;

FIG. 2B is an elevational view of the carrier assembly of FIG. 1 in a deployed position, according to at least one example;

FIG. 3A is a perspective view of the carrier assembly of FIG. 1 in an undeployed position, according to at least one example;

FIG. 3B is an elevational view of the carrier assembly of FIG. 1 in an undeployed position, according to at least one example; and

FIG. 4 is a perspective view of the carrier assembly in a stowed state, according to at least one example.

### DETAILED DESCRIPTION OF THE PREFERRED EMBODIMENTS

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

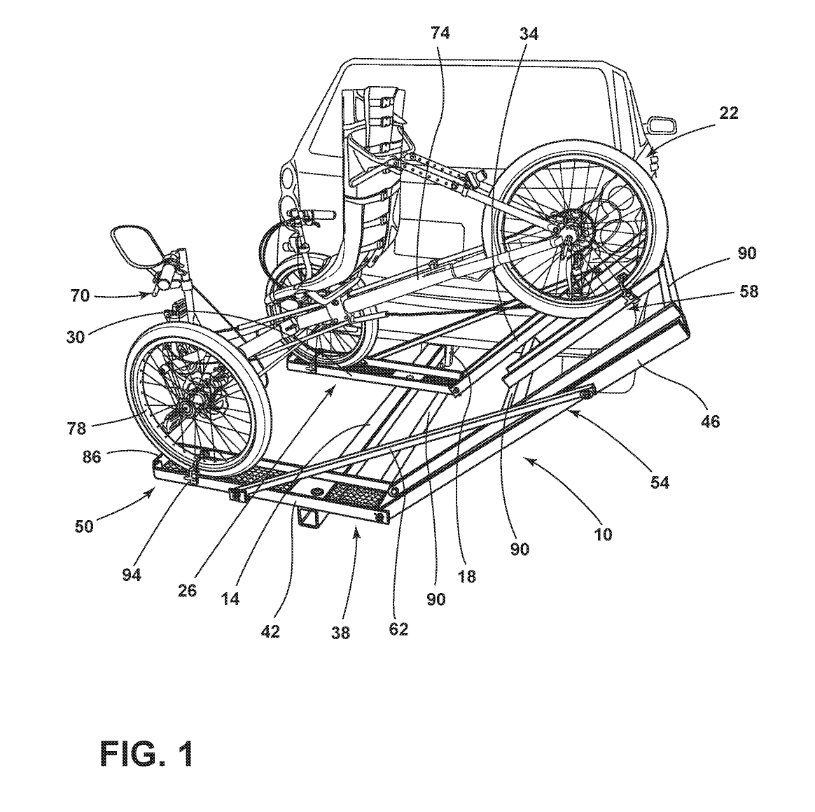

Referring to FIGS. 1-4, reference numeral 10 generally depicts a carrier assembly. The carrier assembly 10 includes a hitch post 14 configured to be received by a trailer hitch 18 of a vehicle 22. The assembly 10 includes a first track assembly 26 may be composed of a first member 30 and the second member 34. A second track assembly 38 may include a third member 42 and a fourth member 46. The first and third members 30, 42 are coupled to the hitch post 14 to define a platform 50. The second and fourth members 34, 46 are rotatably coupled to the respective first and third members 30, 42 to define a rotatable ramp 54. A third track assembly 58 is positioned on the ramp 54 between the second and fourth members 34, 46. An arm 62 extends between the third and fourth members 42, 46.

Referring now to FIG. 1, according to various examples, the carrier assembly 10 may be configured to load, unload, store, transport or otherwise carry a wheeled vehicle 70. In such examples, the carrier assembly 10 may be known as a vehicle carrier assembly 10. In the depicted example, the wheeled vehicle 70 is a three-wheeled recumbent bicycle, but it will be understood that the carrier assembly 10 may be utilized to store or transport a variety of two, three, four or five wheeled vehicles 70. For example, the carrier assembly 10 may be useful in transporting two two-wheeled bicycles, two two-wheeled motorcycles, a tricycle, a three-wheeled motorcycle, a four-wheeled vehicle and/or a five-wheeled vehicle. Further, the carrier assembly 10 may be configured to support and transport non-wheeled (e.g., treads, rollers, etc.) examples of the vehicle 70. The wheeled vehicle 70 includes a frame 74 to which a plurality of wheels 78 are attached. The carrier assembly 10, as explained in greater detail below, is configured to accept and secure the wheels 78 within the first, second and third track assemblies 26, 38, 58 such that the wheeled vehicle 70 may be transported and/or stored.

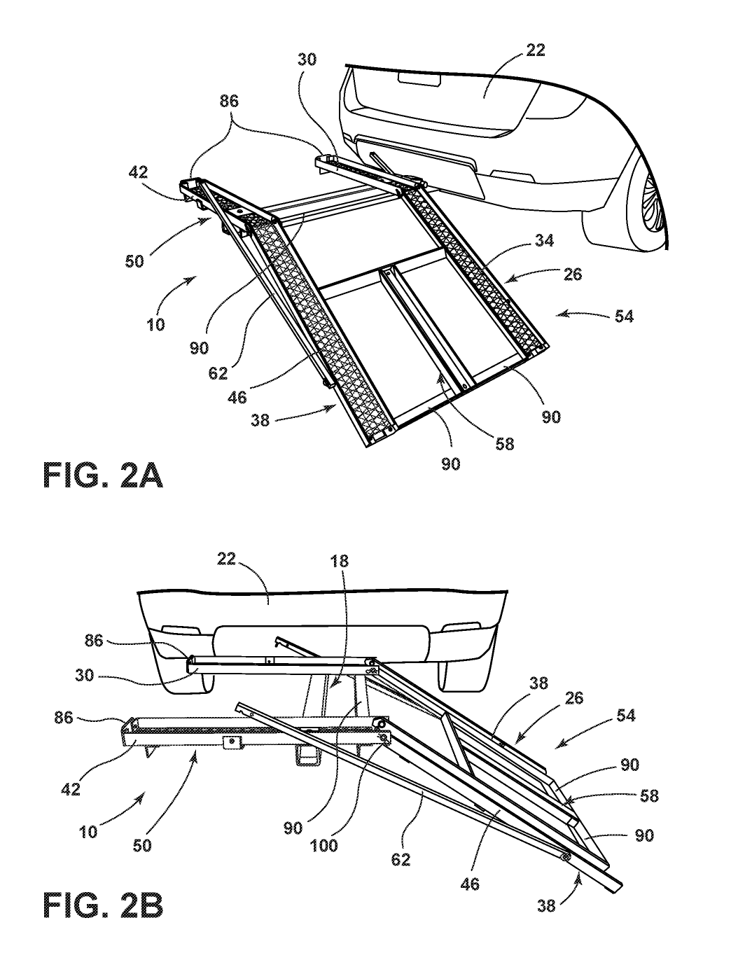

Referring now to FIGS. 1-2B, the hitch post 14 is configured to couple with the trailer hitch 18 of the vehicle 22. The hitch post 14 may have a uniform cross-sectional width or shape, or the cross-sectional width or shape may vary. For example, the hitch post 14 may be thinner or have smaller dimensions proximate an end configured to be received by the trailer hitch 18. The hitch post 14 is supported by the trailer hitch 18 and extends in a vehicle rearward direction away from the vehicle 22. The hitch post 14 may be substantially straight, as depicted, or may have one or more bends. The incorporation of bends into the hitch post 14 may be advantageous in increasing or decreasing a height of the carrier assembly 10. The first and third members 30, 42 of the first and second track assemblies 26, 38 are coupled to a top surface (e.g., as oriented in FIGS. 1-2B) of the hitch post 14 through one or more fasteners (e.g., bolts, screws, etc.). The first and third members 30, 42 of the platform 50 may be substantially horizontal relative to a horizontal plane defined by the vehicle 22 and/or the ground.

The first and second track assemblies 26, 38 are composed of the first, second, third and fourth members 30, 34, 42 46. The first and/or second track assemblies 26, 38 may be composed of a metal, a polymeric material, a composite material and/or combinations thereof. In metallic examples, the first and second track assemblies 26, 38 may be composed of aluminum, steel, galvanized steel and/or other weather resistant metals. In the depicted example, the first, second, third and fourth members 30, 34, 42, 46 are shown as substantially “U” shaped members defining a hollow channel therein. It will be understood that the first, second, third and fourth members 30, 34, 42, 46 may take a variety of shapes configured to accept the wheels 78 of the wheeled vehicle 70 therein. According to various examples, at least one of the first, second and/or third track assemblies 26, 38, 58 may define one or more walls as a mesh. In mesh examples, one or more walls of the track assemblies 26, 38, 58 may define a plurality of holes, slots, grooves or combinations thereof. Mesh examples of the first, second, and/or third track assemblies 26, 38, 58 may be advantageous in both reducing a weight of the carrier assembly 10 as well as allowing water, mud and/or other grime to drain off of the carrier assembly 10. According to various examples, the first and second track assemblies 26, 38 are substantially the same length, but it will be understood that the first track assembly 26 may be shorter or longer than the second track assembly 38. According to various examples, the first second and/or third track assemblies 26, 38, 58 may include one or more end stops 86. The end stops 86 are configured to stop, retain or otherwise keep the wheels 78 of the wheeled vehicle 70 within the channels of the first, second and third track assemblies 26, 38, 58. In the depicted example, the second and third track assemblies 38, 58 include the end stops 86 proximate the platform 50, but it will be understood that all or none of the track assemblies 26, 38, 58 may include the end stops 86.

The third track assembly 58 is positioned on the ramp 54 between the second and fourth members 34, 46 of the first and second track assemblies 26, 38, respectively. As the third track assembly 58 may be positioned in the middle of the second and fourth members 34, 46, the third track assembly 58 may be configured to accept a middle, or third, wheel of the wheeled vehicle 70. According to various examples, the third track assembly 58 may be shorter than at least one of the first and/or second track assemblies 26, 38, but it will be understood that the third track assembly 58 may be longer. In examples where the third track assembly 58 is shorter than at least one of the first and/or second tracks assemblies 26, 38, the third track assembly 58 may be shorter than either of the second and/or fourth members 34, 46. In such an example, the third track assembly 58 may be fully disposed on the ramp 54.

According the various examples, the carrier assembly 10 may include one or more stability bars 90. The stability bars 90 may be positioned on the platform 50 and/or the ramp 54. In examples of the carrier assembly 10 which include the stability bar 90, the stability bar 90 may be positioned on the ramp 54 and coupling the first, second and third track assemblies 26, 38, 58. Stability bars 90 positioned on the platform 50 may couple the first and second track assemblies 26, 38 together. Additionally or alternatively, the stability bars 90 of the platform 50 may further couple to the hitch post 14 for added stability.

In the depicted example, the carrier assembly 10 includes a plurality of attachment features 94. The attachment features 94 are configured to couple with the wheels 78 of the wheeled vehicle 70 such that the wheeled vehicle 70 is secured to the carrier 10. According to various examples, each of the first, second and third track assemblies 26, 38, 58 include at least one attachment feature 94 for securing the wheeled vehicle 70 to the carrier assembly 10. In the depicted example, the attachment features 94 of the first and second track assemblies 26, 38 are positioned on the first and third members 30, 42, respectively, but it will be understood that the second and fourth members 34, 46 may also include attachment features 94. Further, any of the track assemblies 26, 38, 58 may include a plurality of attachment features 94. In some examples, one or more of the attachment features 94 may be movable along the first, second and third track assemblies 26, 38, 58, while in one or more attachment features 94 are fixed. The attachment features 94 may take a variety of configurations including straps, clamps, locks, cables, bolts, other fixing mechanisms and the like. The attachment features 94 may extend through the channels or over the channels of the first, second and/or third track assemblies 26, 38, 58. According to various examples, the attachment features 94 may be locking and require a key or combination to be released. Such a feature may be advantageous in decreasing a probability of the wheeled vehicle 70 being stolen or falling off the carrier assembly 10 while the vehicle 22 is in motion.

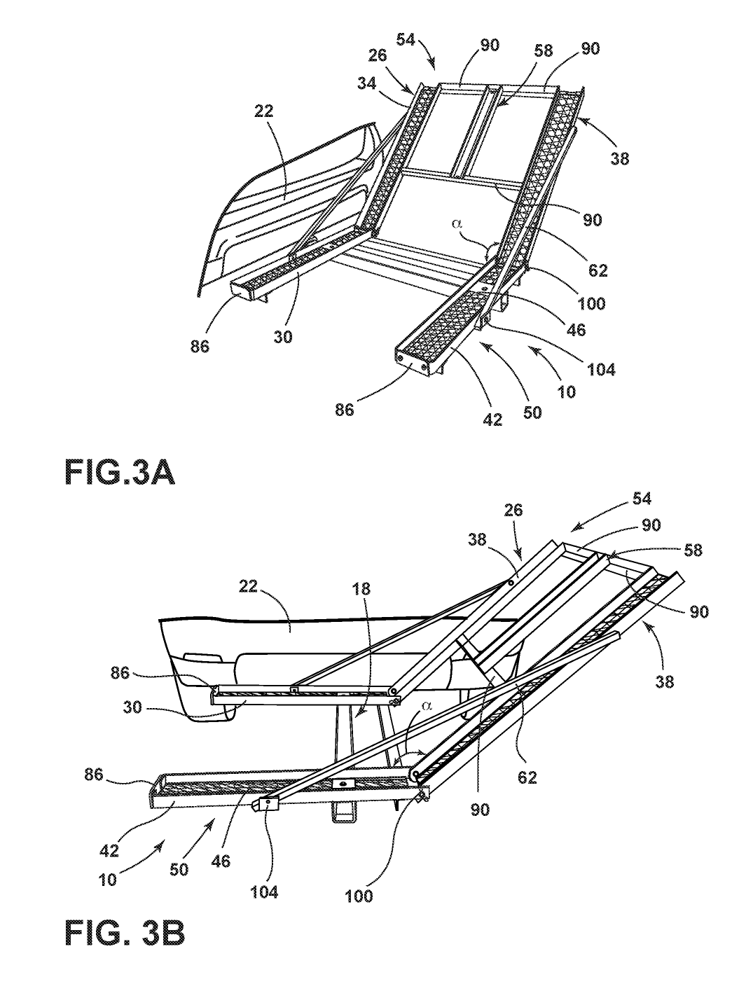

Referring now to FIGS. 2A-3B, the ramp 54 is pivotally and rotatably coupled to the platform 50. The second and fourth members 34, 46 of the ramp 54 are coupled to the first and third members 30, 42 through pivot points 100. In the depicted example, the second and fourth members 34, 46 are coupled inside of the first and third members 30, 42, but it will be understood that the first and third members 30, 42 may be coupled inside of the second and fourth members 34, 46 without departing from the teachings provided herein. The pivot points 100 may include bushings composed of a low friction material (e.g., nylon) which aid in the rotation of the ramp 54 relative to the platform 50.

The ramp 54 is operable between deployed (e.g., FIGS. 2A and 2B) and undeployed (FIGS. 3A and 3B) positions. In the deployed position, the ramp 54 is in contact with a ground beneath the carrier assembly 10. In other words, the ramp 54 may rest on the ground. In other examples, an end of the ramp 54 may be positioned just above the ground when the ramp 54 is in the deployed position. In such an example, the deployed position of the ramp 54 may be controlled via a detent and/or other mechanism or feature to stop the ramp 54. In the undeployed position, the ramp 54 may be at an angle α relative to a plane defined by the platform 50. The angle α between the ramp 54 and the platform 50 may be from about 90° to about 180°. For example, the angle α between the ramp 54 and the platform 50 in the undeployed position may be about 95° or greater, about 100° or greater, about 110° or greater, about 120° or greater, about 130° or greater, about 140° or greater, about 150° or greater, about 160° or greater, or about 170° or greater. In yet other examples, the angle α between the ramp 54 and the platform 50 in the undeployed position may be about 170° or less, about 160° or less, about 150° or less, about 140° or less, about 130° or less, about 120° or less, about 110° or less, about 100° or less, or about 95° or less.

The ramp 54 is held in the undeployed position via the arm 62. In the depicted example, the carrier assembly 10 includes two separate arms 62, but it will be understood that the carrier assembly 10 may include only a single arm 62 or more than two arms 62. The arm 62 is pivotally coupled to the ramp 54 (e.g., to at least one of the second and fourth members 34, 46) and extends to the platform 50 when engaged. The arms 62 are may be metal bars (e.g., hollow, solid, open, closed, etc.), cylinder (e.g., hydraulic, pneumatic and/or spring), rope and pulley systems, or other devices for coupling the ramp 54 and the platform 50. Cylinder examples of the arms 62 may be advantageous in that both ends of the arm 62 may remain connected regardless of whether the ramp 54 is in the deployed or undeployed position. Further, cylinder examples of the arms may allow for the height or angle α of the ramp 54 to be set. Even further, cylinder examples of the arms 62 may include a self-locking feature. In examples of the arms 62 which utilize a metal bar, each of the arms 62 may couple with a locking feature 104. The locking features 104 are positioned on outboard sides of the first and third members 30, 42, and are configured to lock the arms 62 in place such that the arms 62 hold the ramp 54 in the undeployed position. Releasing of the arms 62 from the locking features 104 may allow the ramp 54 to rotate between the undeployed and deployed positions. It will be understood that the locking features 104 may still be utilized in examples of the arms 62 which incorporate the cylinders.

As the ramp 54 may form an angle with the platform of less than about 180°, the wheeled vehicle 70 may be stored at an angle on the carrier assembly 10. As such, the wheeled vehicle 70 may be stored at a minor, partially, substantially vertical angle relative to a horizontal plane defined by the platform 50 and/or ground. As the wheeled vehicle 70 is stored at a vertical angle, wheeled vehicles 70 which are longer than the vehicle 22 is wide may be stored with little to no horizontal overhang relative to the vehicle 22. For example, by decreasing the angle α between the platform 50 and the ramp 54, the length of the wheeled vehicle 70 is translated in an upward and inboard direction thereby reducing or eliminating the amount of wheeled vehicle 70 protruding from the side of the vehicle 22. Such a feature may be advantageous in reducing the likelihood of damage occurring to the wheeled vehicle 70 by decreasing an area which might be hit by an object or other vehicles.

In operation, the wheeled vehicle 70 is loaded onto the carrier assembly 10 while the ramp 54 is in the deployed position. While in the deployed position, the ramp 54 may be in contact with a ground beneath the carrier assembly 10, or an edge of the ramp 54 may be positioned sufficiently close to the ground that wheels 78 of the wheeled 70 may be rolled onto the ramp 54. An operator of the carrier assembly 10 aligns the wheels 78 of the wheeled vehicle 70 with the first, second and third track assemblies 26, 38, 58. Once aligned, the wheeled vehicle 70 is pushed up the ramp 54 and onto the platform 50. At this point, each wheel 78 of the wheeled vehicle 70 is positioned within a track assembly 26, 38, 58. Once the wheels 78 are properly positioned, one or more of the attachment features 94 may be attached to the wheels 78. Next, the ramp 54 is transitioned from the deployed position to the undeployed position and one or more of the arms 62 are locked.

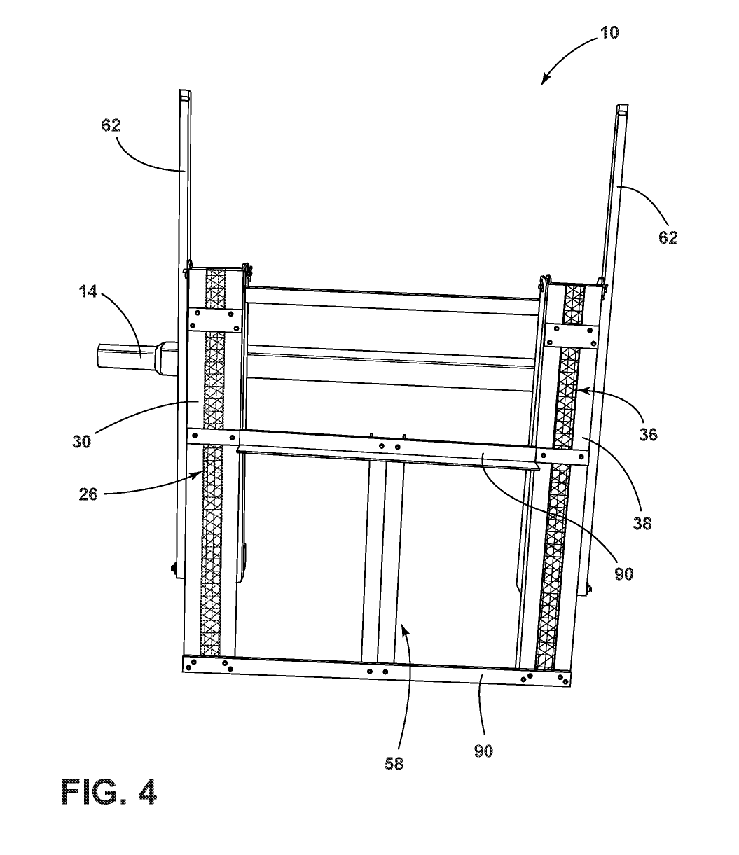

Referring now to FIG. 4, the carrier assembly 10 may be capable of being folded into a stowed configuration. In such an example, the ramp 54 is further rotatably operable to the stowed position in which the platform 50 and the ramp 54 are mated together. According to various examples, the second and fourth members 34, 46 may be thinner than the first and third members 30, 42 of the first and second track assemblies 26, 38. Such a feature may be advantageous in allowing the second and fourth members 34, 46 to mate into the first and third members 30, 42 during rotating of the ramp 54 and/or storing of the carrier assembly 10. For example, the ramp 54 may be rotated onto the platform 50 such that the second and fourth members 34, 46 are positioned within the first and third members 30, 42. It will be understood that in alternative examples, the first and third members 30, 42 may be thinner than the second and fourth members 34, 46 such that the same folding and mating configuration may be obtained without departing from the teachings provided herein. It will be understood that the attachment features 94 may be utilized to keep the carrier assembly 10 in the stowed configuration. For example, in addition to being configured to couple to the wheels 78 of the wheeled vehicle 70, the attachment features 94 may couple to the corresponding mating member and retain the ramp 54 to the platform 50. Once the ramp 54 and the platform 50 have been mated, the hitch post 14 may be removed from the trailer hitch 18 and the carrier assembly 10 may be stored. The stowed configuration of the carrier assembly 10 may be particularly advantageous in decreasing a physical footprint of the carrier assembly 10 thereby decreasing the area needed for storage.

Use of the present disclosure may offer a variety of advantages. First, as the ramp 54 is in contact, or in close proximity, to the ground beneath the vehicle 22, the wheeled vehicle 70 may not need to be lifted for loading onto the carrier assembly 10. As explained above, the wheels 78 of the wheeled vehicle 70 may ride up the first, second and third track assemblies 26, 38, 58 such that lifting of the wheeled vehicle 70 may not be required. Second, as the wheeled vehicle 70 is stored at an angle, the carrier assembly 10 allows for little to no overhang of the wheeled vehicle 70 relative to the width of the vehicle 22. As explained above, because the wheeled vehicle 70 is stored along the longer diagonal dimension of the vehicle 22, a wheeled vehicle 70 which is longer than the vehicle 22 is wide may still be stored with little to no overhang. Decreasing overhang of the wheeled vehicle 70 from the vehicle 22 may be advantageous in decreasing the chances of damage to the wheeled vehicle 70 and/or the vehicle 22. Third, use of the mesh examples of the first, second and/or third track assemblies 26, 38, 58 may be advantageous in both decreasing weight of the carrier assembly 10 as well as allowing collected water to run off. Fourth, the stowed configuration of the carrier assembly 10 and the mating of the second and fourth members 34, 46 with the first and third members 30, 42 allows for a compact storage of the carrier assembly 10.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

It will be apparent to those skilled in the art that various modifications and variations can be made to the present disclosure without departing from the spirit and scope of the disclosure. Thus, it is intended that the present disclosure cover such modifications and variations provided they come within the scope of the appended claims and their equivalents.

What is claimed is:

1. A vehicle carrier assembly, comprising:
a hitch post configured to be received by a vehicle trailer hitch;
a first track assembly comprising a first member and a second member;
a second track assembly comprising a third member and a fourth member, wherein the first and third members are coupled to the hitch post to define a platform and the second and fourth members are rotatably coupled to the respective first and third members to define a rotatable ramp;
a third track assembly positioned on the ramp between the second and fourth members; and
an arm extending between the third and fourth members.

2. The assembly of claim 1, wherein the arm comprises a hydraulic cylinder.

3. The assembly of claim 1, wherein at least one of the first, second and third track assemblies comprises a mesh.

4. The assembly of claim 3, wherein the second and fourth members are thinner than the first and third members.

5. The assembly of claim 4, wherein the second and fourth members are configured to mate into the first and third members.

6. The assembly of claim 5, wherein the first and third members of the platform are substantially horizontal.

7. A vehicle carrier assembly, comprising:
a hitch post;
a first track assembly comprising a first member and a second member;
a second track assembly comprising a third member and a fourth member, wherein the first and third members are coupled to the hitch post to define a platform and the second and fourth members are rotatably coupled to the respective first and third members to define a rotatable ramp; and
a third track assembly positioned on the ramp between the second and fourth members.

8. The assembly of claim 7, wherein the third track assembly is shorter than either of the second and fourth members.

9. The assembly of claim 8, wherein the third track assembly is fully disposed on the ramp.

10. The assembly of claim 9, further comprising:
a stability bar positioned on the ramp and coupling the first, second and third track assemblies together.

11. The assembly of claim 7, wherein each of the first, second and third track assemblies defines a hollow channel.

12. The assembly of claim 11, further comprising:
an attachment feature extending over and/or through the hollow channel of the third track assembly.

13. The assembly claim 7, wherein the second and fourth members are thinner than the first and third members.

14. The assembly of claim 13, wherein the second and fourth members are configured to mate into the first and third members.

15. A carrier assembly, comprising:
a hitch post;
a first track assembly;
a second track assembly, the first and second track assemblies coupled to the hitch post to define a platform and a ramp, wherein the ramp is rotatably coupled to the platform and operable between deployed and undeployed positions; and
a third track assembly positioned on the ramp and positioned between the first and second track assemblies.

16. The assembly of claim 15, wherein the ramp is in contact with a ground beneath the carrier assembly in the deployed position.

17. The assembly of claim 16, wherein an angle defined between the ramp and the platform in the undeployed position is from about 90° to about 180°.

18. The assembly of claim 17, wherein the ramp is further rotatably operable to a stowed position.

19. The assembly of claim 18, wherein the first and second track assemblies are substantially the same length.

20. The assembly of claim 18, wherein the third track assembly is shorter than at least one of the first and second track assemblies.
